(19) United States
(12) Patent Application Publication
(10) Pub. No.: US 2026/0370138 A1
(43) Pub. Date: Nov. 19, 2026

(54) POWER CONVERSION CIRCUIT AND POWER CONVERTER USING SAME

(71) Applicant: Delta Electronics, Inc., Taoyuan City (TW)

(72) Inventors: Qiang He, Shanghai (CN); Yimin Pan, Shanghai (CN)

(21) Appl. No.: 19/655,021

(22) Filed: Apr. 22, 2026

(30) Foreign Application Priority Data
May 15, 2025 (CN) 202510628895.1
May 15, 2025 (CN) 202520958618.2

(51) Int. Cl. H02M 3/00; H01F 27/24; H01F 27/29; H01F 27/30; H02M 1/00; H02M 3/158

(52) U.S. Cl. CPC H02M 3/01; H01F 27/24; H01F 27/29; H01F 27/306; H02M 1/0095; H02M 3/1586

(57) ABSTRACT

A power conversion circuit includes a first power terminal, a second power terminal, a first switching power conversion unit, a second switching power conversion unit, a flying capacitor and a magnetic element. The first switching power conversion unit includes a first switch and a third switch. The second switching power conversion unit includes a second switch and a fourth switch. The third switch is electrically connected to the first switch. The fourth switch is electrically connected to the second switch. The magnetic element includes two first windings and a second winding, which are magnetically coupled with each other. A first one of the two first windings is serially connected between the flying capacitor and the second power terminal. A second one of the two first windings is electrically connected between the second switch and the second power terminal.

### CROSS-REFERENCE TO RELATED APPLICATION

This application claims priority to China Patent Application No. 202510628895.1, filed on May 15, 2025, and claims priority to China Patent Application No. 202520958618.2, filed on May 15, 2025. The entireties of the above-mentioned patent applications are incorporated herein by reference for all purposes.

### TECHNICAL FIELD

The present disclosure relates to a power conversion circuit, and more particularly to a power conversion circuit capable of flexibly designing a voltage gain and a power converter with the power conversion circuit.

### BACKGROUND

In the application of existing non-isolated large current power conversion circuits, resonant circuit topologies with expandable duty-cycle are usually adopted. The power conversion circuits having the resonant circuit topologies with expandable duty-cycle are usually categorized into symmetric and asymmetric types. Regardless of the type of the power conversion circuit, the voltage gain (i.e., the ratio of the output voltage to the input voltage) is fixed and cannot be designed and adjusted according to actual application requirements. Due to the fixed voltage gain, the applications of the power conversion circuits having the resonant circuit topologies with expandable duty-cycle are limited.

### SUMMARY

The present disclosure provides a power conversion circuit and a power converter with the power conversion circuit. The voltage gain of the power conversion circuit can be flexibly designed. Consequently, the applications of the power conversion circuit are expanded.

In accordance with an aspect of the present disclosure, a power conversion circuit is provided. The power conversion circuit includes a first power terminal, a second power terminal, a first switching power conversion unit, a second switching power conversion unit, a flying capacitor and a magnetic element. The first power terminal includes a first positive terminal and a first negative terminal. The second power terminal includes a second positive terminal and a second negative terminal. The second negative terminal is electrically connected to the first negative terminal. The first switching power conversion unit includes a first switch and a third switch, which are electrically connected to each other in series. The second switching power conversion unit includes a second switch and a fourth switch, which are electrically connected to each other in series. A first terminal of the first switch is electrically connected to a first terminal of the second switch. A second terminal of the first switch is electrically connected to the first positive terminal. The third switch is electrically connected to the first switch in series. The fourth switch is electrically connected to the second switch in series. A first terminal of the third switch and a first terminal of the fourth switch are electrically connected to the first negative terminal. A second terminal of the fourth switch is electrically connected to a second terminal of the second switch. The first switch, the second switch, the third switch and the fourth switch perform periodic actions in a switching period. The switching period has a duty cycle. The magnetic element includes two first windings and a second winding, which are magnetically coupled with each other. The second terminals of the first windings have opposite polarities and are electrically connected together and connected to the second positive terminal. A first terminal of a first one of the two first windings is electrically connected to the second terminal of the third switch. A first terminal of a second one of the two first windings is electrically connected between the second terminal of the fourth switch and a second terminal of the second switch. The second winding and the flying capacitor are electrically connected in series between the first terminal of the first switch and the first terminal of the first one of the two first windings. A first terminal of the second winding and the first terminal of the first one of the two first windings have a same polarity. A turn ratio between the second winding, the first one of the two first windings and the second one of the two first windings is N:1:1, where N is a positive number. The switching period includes a first operating interval and a second operating interval. During the first operating interval, a current flowing through the second winding is equal to a current flowing through the first one of the two first windings. During the second operating interval, the current flowing through the second winding is equal to a current flowing through the second one of the two first windings.

In accordance with an aspect of the present disclosure, a power converter is provided. The power converter includes M power conversion circuits, wherein M is an integer greater than 1. The first power terminals of the M power conversion circuits are electrically connected to each other in parallel. The second power terminals of the M power conversion circuits are electrically connected to each other in parallel. If M is an odd number, the M power conversion circuits are respectively controlled by M control signals, and a phase angle between every two adjacent control signals is an angle of any value between [360/M−20, 360/M+20] degrees. If M is an even number, the M power conversion circuits are controlled by M/2 control signals, an m-th and an (N/2+m)-th power conversion circuits are controlled by an m-th control signal, and a phase angle between every two adjacent control signals is an angle of any value between [360/M−20, 360/M+20] degrees.

In accordance with an aspect of the present disclosure, a power conversion circuit is provided. The power conversion circuit includes a first power terminal, a second power terminal, a first flying capacitor, a second flying capacitor, a first switching power conversion unit, a second switching power conversion unit and a magnetic element. The first power terminal includes a first positive terminal and a first negative terminal. The second power terminal includes a second positive terminal and a second negative terminal. The second negative terminal is electrically connected to the first negative terminal. The first switching power conversion unit includes a first switch, a second switch and a third switch. A first terminal of the first switch is electrically connected to the first positive terminal. A second terminal of the second switch is electrically connected to a first terminal of the third switch. A second terminal of the third switch is electrically connected to the second negative terminal. The second switching power conversion unit includes a fourth switch, a fifth switch and a sixth switch. A first terminal of the fourth switch is electrically connected to the first positive terminal. A second terminal of the fifth switch is electrically connected to a first terminal of the sixth switch. A second terminal of the sixth switch is electrically connected to the second negative terminal. A second terminal of the fourth switch is electrically connected to a first terminal of the second switch. A first terminal of the fifth switch is electrically connected to the second terminal of the first switch. The first switch, the second switch, the third switch, the fourth switch, the fifth switch and the sixth switch perform periodic actions in a switching period. The switching period has a duty cycle. The magnetic element includes two first windings and two second windings, which are magnetically coupled with each other. The second terminals of the first windings have opposite polarities and are electrically connected together and connected to the second positive terminal. A first terminal of a first one of the two first windings is electrically connected to the second terminal of the fifth switch and the first terminal of the sixth switch. A first terminal of a second one of the two first windings is electrically connected between the second terminal of the second switch and the first terminal of the third switch. A first one of the two second windings and the second flying capacitor are electrically connected in series between the second terminal of the fourth switch and the second terminal of the fifth switch. A second one of the two second windings and the first flying capacitor are electrically connected in series between the second terminal of the first switch and the second terminal of the second switch. A first terminal of the first one of the two second windings and the first terminal of the first one of the two first windings have a same polarity and are electrically connected to each other. A turn ratio between the first one of the two second windings, the second one of the two second windings, the first one of the two first windings and the second one of the two first windings is N:N:1:1, where N is a positive number. The switching period contains a first operating interval and a second operating interval. During the first operating interval, a total current flowing through the two second windings is equal to a current flowing through the first one of the two first windings. During the second operating interval, the total current flowing through the two second windings is equal to a current flowing through the second one of the two first windings.

In accordance with an aspect of the present disclosure, a power converter is provided. The power converter includes M power conversion circuits, wherein M is an integer greater than 1. The first power terminals of the M power conversion circuits are electrically connected to each other in parallel. The second power terminals of the M power conversion circuits are electrically connected to each other in parallel. The M power conversion circuits are respectively controlled by M control signals. A phase angle between every two adjacent control signals is an angle of any value between [360/2M−20, 360/2M+20] degrees.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1A is a schematic circuit diagram illustrating the circuitry topology of a power conversion circuit according to a first embodiment of the present disclosure;

FIG. 1B is a schematic timing waveform diagram illustrating associated signals of the power conversion circuit shown in FIG. 1A;

FIG. 1C is a schematic circuit diagram illustrating the equivalent circuit of the power conversion circuit shown in FIG. 1A in the time interval between the time point t0 and the time point t1 shown in FIG. 1B;

FIG. 1D is a schematic circuit diagram illustrating the equivalent circuit of the power conversion circuit shown in FIG. 1A in the time interval between the time point t2 and the time point t3 shown in FIG. 1B;

FIG. 1E is a schematic circuit diagram illustrating the circuitry topology of a power conversion circuit according to a second embodiment of the present disclosure;

FIG. 2A is a schematic circuit diagram illustrating the circuitry topology of a power conversion circuit according to a third embodiment of the present disclosure;

FIG. 2B is a schematic timing waveform diagram illustrating associated signals of the power conversion circuit shown in FIG. 2A;

FIG. 2C is a schematic circuit diagram illustrating the equivalent circuit of the power conversion circuit shown in FIG. 2A in the time interval between the time point t0 and the time point t1 shown in FIG. 2B;

FIG. 2D is a schematic circuit diagram illustrating the equivalent circuit of the power conversion circuit shown in FIG. 2A in the time interval between the time point t2 and the time point t3 shown in FIG. 2B;

FIG. 2E is a schematic circuit diagram illustrating the circuitry topology of a power conversion circuit according to a fourth embodiment of the present disclosure;

FIG. 3 is a schematic circuit diagram illustrating the circuitry topology of a power converter according to a first embodiment of the present disclosure; and

FIG. 4 is a schematic circuit diagram illustrating the circuitry topology of a power converter according to a second embodiment of the present disclosure.

### DETAILED DESCRIPTION

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

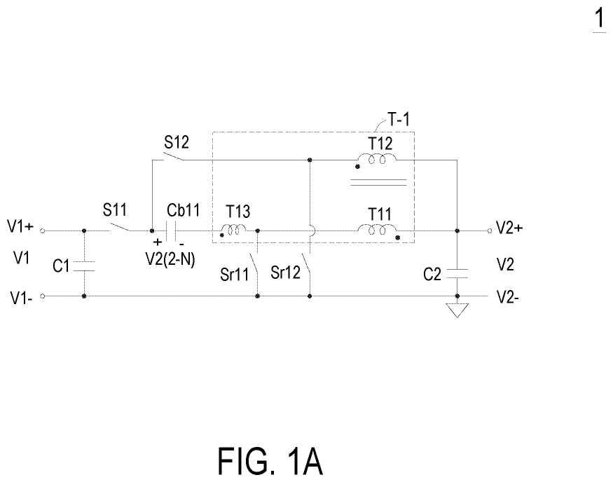

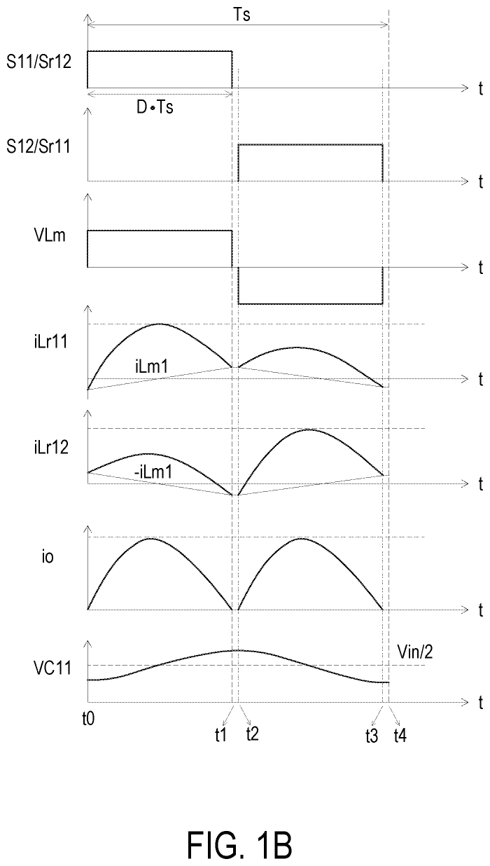

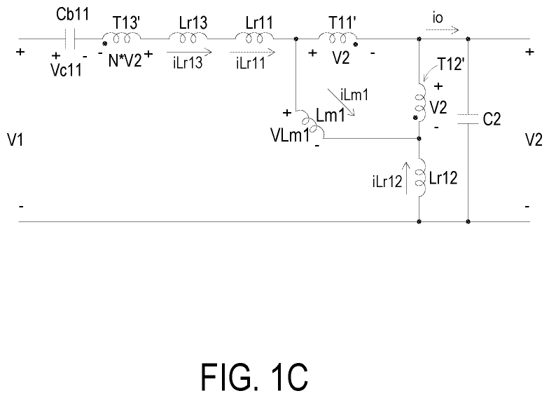

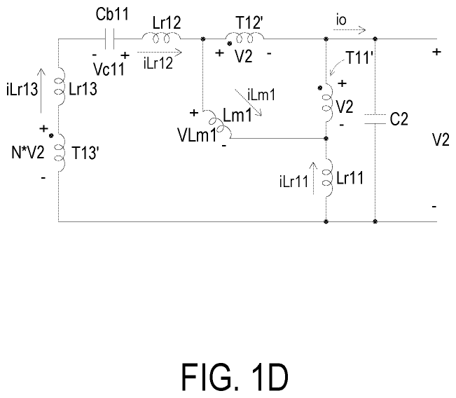

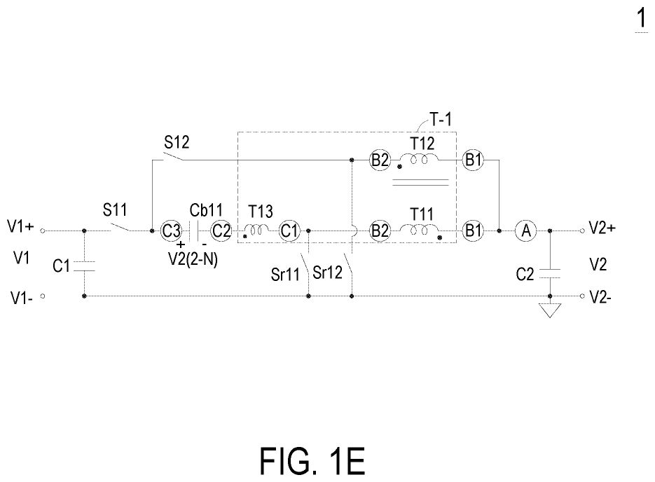

FIG. 1A is a schematic circuit diagram illustrating the circuitry topology of a power conversion circuit according to a first embodiment of the present disclosure. FIG. 1B is a schematic timing waveform diagram illustrating associated signals of the power conversion circuit shown in FIG. 1A. FIG. 1C is a schematic circuit diagram illustrating the equivalent circuit of the power conversion circuit shown in FIG. 1A in the time interval between the time point t0 and the time point t1 shown in FIG. 1B. FIG. 1D is a schematic circuit diagram illustrating the equivalent circuit of the power conversion circuit shown in FIG. 1A in the time interval between the time point t2 and the time point t3 shown in FIG. 1B.

In accordance with the present disclosure, the power conversion circuit can perform bidirectional power conversion. In case that the first power terminal of the power conversion circuit is the input terminal, the second power terminal of the power conversion circuit is the output terminal. In case that the first power terminal of the power conversion circuit is the output terminal, the second power terminal of the power conversion circuit is the input terminal. The power conversion circuit includes a resonant circuit topology with expandable duty-cycle. As shown in FIG. 1A, in the embodiment, the power conversion circuit 1 includes an asymmetric circuit topology. The power conversion circuit 1 includes a first power terminal (including a first positive terminal V1+ and a first negative terminal V1−), a second power terminal (including a second positive terminal V2+ and a second negative terminal V2−), a first switching power conversion unit, a second switching power conversion unit, a first capacitor C1, a second capacitor C2, a flying capacitor Cb11 and a magnetic element T-1. The first negative terminal V1− and the second negative terminal V2− are connected to a common node (e.g., a ground terminal).

The first switching power conversion unit includes a first switch S11 and a third switch Sr11, which are electrically connected to each other in series. The second switching power conversion unit includes a second switch S12 and a fourth switch Sr12, which are electrically connected to each other in series. The first switch S11, the second switch S12, the third switch Sr11 and the fourth switch Sr12 perform periodic actions in each switching period. The switching period has a duty cycle.

The first terminal of the first switch S11 is electrically connected to the first terminal of the second switch S12. The second terminal of the first switch S11 is electrically connected to the first positive terminal V1+. The second terminal of the fourth switch Sr12 is electrically connected to the second terminal of the second switch S12. The first terminal of the third switch Sr11 and the first terminal of the fourth switch Sr12 are electrically connected to each other and connected to the first negative terminal V2−.

The on/off states (i.e., switching state) of the first switch S11 are identical to the on/off states of the fourth switch Sr12. The on/off states of the second switch S12 are identical to the on/off states of the third switch Sr11. The phase difference between the driving signal of the first switch S11 and the driving signal of the second switch S12 is 180 degrees. The on duration of each of the first switch S11 and the second switch S12 is less than or equal to a half of the switching period and greater than or equal to 0.4 times the switching period. The first capacitor C1 is electrically connected between the first positive terminal V1+ and the first negative terminal V1−. The second capacitor C2 is electrically connected between the second positive terminal V2+ and the second negative terminal V2−.

The magnetic element T-1 includes two first windings T11 and T12 and a second winding T13. The two first windings T11 and T12 and the second winding T13 are magnetically coupled with each other through a common magnetic core and wound on the same magnetic leg. The second terminals of the first windings T11 and T12, which have opposite polarities, are electrically connected together and connected to the second positive terminal V2+. The first terminal of the first winding T11 is electrically connected to the second terminal of the third switch Sr11. The first terminal of the other first winding T12 is electrically connected between the second terminal of the fourth switch Sr12 and the second terminal of the second switch S12. The second winding T13 and the flying capacitor Cb11 are electrically connected to each other in series. The serial connection structure of the second winding T13 and the flying capacitor Cb11 is electrically connected between the first terminal of the first switch S11, the second terminal of the third switch Sr11 and the first winding T11. The turn ratio of the second winding T13, the first winding T11 and the first winding T12 is N:1:1, where N is a positive number, in some embodiments N is a positive integer. The position sequence of the second winding T13 and the flying capacitor Cb11 is not restricted, as long as they meet the series relationship.

In an embodiment, the first terminal of the second winding T13 is electrically connected to the first terminal of the first winding T11. The first terminal of the second winding T13 and the first terminal of the first winding T11 have the same polarity. The second terminal of the second winding T13 is electrically connected to the flying capacitor Cb11. In a variant example, the positions of the flying capacitor Cb11 and the second winding T13 are exchanged. That is, the first terminal of the flying capacitor Cb11 is electrically connected to the first terminal of the first winding T11, and the second terminal of the flying capacitor Cb11 is electrically connected to the first terminal of the second winding T13. The first terminal of the second winding T13 and the first terminal of the first winding T11 have the same polarity.

The voltage gain ratio of the power conversion circuit 1 will be described as follows. For illustration, it is assumed that the first power terminal of the power conversion circuit 1 is the input voltage terminal and the second power terminal of the power conversion circuit 1 is the output voltage terminal. Please refer to FIGS. 1A, 1B, 1C and 1D again. In the steady state of the power conversion circuit 1, the time interval between the time point t0 and the time point t4 is a switching period Ts.

In the time interval between the time point t0 and the time point t1, the first switch S11 and the fourth switch Sr12 are turned on. This time interval can be designated as a first operating interval. During this interval, the input voltage V1 charges the flying capacitor Cb11 through the first switch S11, and the energy is transferred to the output terminal through the second winding T13 and the first winding T11. In addition, the first winding T12 provides the freewheeling current through the fourth switch Sr12. Meanwhile, the current flowing through the second winding T13 is equal to the current flowing through the first winding T11. The equivalent circuit is shown in FIG. 1C. In FIG. 1C, T11', T12′ and T13′ are the ideal windings corresponding to each winding, Lr11, Lr12, Lr13 are the equivalent leakage inductors corresponding to each winding, and Lm1 is the equivalent magnetizing inductor of the magnetic element T-1.

The equivalent resonant inductor formed by the equivalent leakage inductors Lr11, Lr12, and Lr13 resonates with the flying capacitor Cb11 to generate resonant currents iLr11 and iLr12. The magnetizing current in this magnetic element is equivalent to iLm1. During this time interval, the corresponding node voltage relationships in the power conversion circuit 1 can be seen in FIG. 1C. Ideally, the voltage across the first winding T12′ is equal to the voltage at the second power terminal of the power conversion circuit 1 (e.g., V2). The turn ratio between the second winding T13, the first winding T11 and the first winding T12 is N:1:1. Consequently, the ideal voltage across the first winding T11′ is also equal to V2, and the ideal voltage across the second winding T13′ is N×V2. As a consequence, the voltage V1 at the first power terminal of the power conversion circuit 1 can be expressed as the following equation (1):

V1=Vc11+(2−n)×V2 . . .. (1)

In the above equation (1), Vc11 is the terminal voltage of the flying capacitor Cb11. At the time point t1, the resonant currents iLr11 and iLr12 are equal to the magnetizing currents iLm1 and −iLm1, respectively. Meanwhile, the first switch S11 and the fourth switch Sr12 are turned off to achieve the zero current switching (ZCS) function of switches. Consequently, the turn-off loss of switches is reduced, and the energy transfer efficiency of the power conversion circuit 1 is enhanced.

In the time interval between the time point t1 and the time point t2, all switches are turned off. The magnetizing current iLm1 flowing through the magnetic element T-1 provides the freewheeling current to draw charges from the parasitic capacitances across the second switch S12 and the third switch Sr11. Consequently, the voltages across the second switch S12 and the third switch Sr11 decrease. In an embodiment, when the voltages across the second switch S12 and the third switch Sr11 drop to less than 50% of their respective initial voltages (i.e., the voltage across the respective switches at the time point t1), the second switch S12 and the third switch Sr11 are turned on. Consequently, the turn-on loss of switches can be reduced, and the energy conversion efficiency and the power density of the power conversion circuit will be enhanced.

In another embodiment, the inductance of the magnetic element T-1 is controlled to allow the inductance of the equivalent magnetizing inductor Lm1 of the magnetic element T-1 to be sufficiently small. That is, the magnetizing current iLm1 flowing through the equivalent magnetizing inductor Lm1 is sufficiently large to completely draw the charges of the parasitic capacitances across the second switch S12 and the third switch Sr11. Consequently, the voltages across the second switch S12 and the third switch Sr11 drop to zero. After the body diodes of the second switch S12 and the third switch Sr11 are turned on, the second switch S12 and the third switch Sr11 are turned on to achieve the zero-voltage switching (ZVS) function of switches. Consequently, the turn-on loss of switches can be further reduced, and the energy conversion efficiency and the power density of the power conversion circuit 1 can be further enhanced.

In the time interval between the time point t2 and the time point t3, the second switch S12 and the third switch Sr11 are turned on. This time interval can be designated as a second operating interval. Meanwhile, the energy stored in the flying capacitor Cb11 is transferred to the output terminal through the second switch S12, the first winding T12, the third switch Sr11 and the second winding T13. In addition, the first winding T11 provides the freewheeling current through the third switch Sr11. Meanwhile, the current flowing through the second winding T13 is equal to the current flowing through the first winding T12. The equivalent circuit is shown in FIG. 1D.

The equivalent resonant inductor formed by the equivalent leakage inductors Lr11, Lr12, and Lr13 resonates with the flying capacitor Cb11 to generate resonant currents iLr11 and iLr12. The magnetizing current in this magnetic element is equivalent to iLm1. During this time interval, the corresponding node voltage relationships in the power conversion circuit 1 can be seen in FIG. 1D. Ideally, the voltage across the first winding T11′ is equal to the voltage at the second power terminal of the power conversion circuit 1 (e.g., V2). The turn ratio between the second winding T13, the first winding T11 and the first winding T12 is N:1:1. Consequently, the ideal voltage across the first winding T12′ is also equal to V2, and the ideal voltage across the second winding T13′ is N×V2. As a consequence, the voltage Vc11 across the flying capacitor Cb11 can be expressed as the following equation (2):

Vc11=(2−n)×V2 . . . (2);

The energy stored in the flying capacitor Cb11 in the time interval between the time point t0 and the time point t1 is transferred to the output terminal in the time interval between the time point t2 and the time point t3. After the equation (2) is substituted into the equation (1), the voltage V1 at the first power terminal of the power conversion circuit 1 can be expressed as: V1=(4−2N)××2.

At the time point t3, the resonant currents iLr11 and iLr12 are equal to the magnetizing currents iLm1 and −iLm1, respectively. Meanwhile, the second switch S12 and the third switch Sr11 are turned off to achieve the zero current switching (ZCS) function of switches. Consequently, the turn-off loss of switches is reduced, and the energy transfer efficiency of the power conversion circuit 1 is enhanced.

In the time interval between the time point t3 and the time point t4, all switches are turned off. The magnetizing current iLm1 flowing through the first windings T11 and T12 provides the freewheeling current to draw charges from the parasitic capacitances across the first switch S11 and the fourth switch Sr12. Consequently, the voltages across the first switch S11 and the fourth switch Sr12 decrease.

In an embodiment, when the voltages across the first switch S11 and the fourth switch Sr12 drop to less than 50% of their respective initial voltages (i.e., the voltage across the respective switches at the time point t1), the first switch S11 and the fourth switch Sr12 are turned on. Consequently, the turn-on loss of switches can be reduced, and the energy conversion efficiency and the power density of the power conversion circuit 1 will be enhanced.

In another embodiment, the inductance of the magnetic element T-1 is controlled to allow the inductance of the equivalent magnetizing inductor Lm1 of the magnetic element T-1 to be sufficiently small. That is, the magnetizing current iLm1 flowing through the equivalent magnetizing inductor Lm1 is sufficiently large to completely draw the charges of the parasitic capacitances across the first switch S11 and the fourth switch Sr12. Consequently, the voltages across the first switch S11 and the fourth switch Sr12 drop to zero. After the body diodes of the first switch S11 and the fourth switch Sr12 are turned on, the first switch S11 and the fourth switch Sr12 are turned on to achieve the zero-voltage switching (ZVS) function of switches. Consequently, the turn-on loss of switches can be further reduced, and the energy conversion efficiency and the power density of the power conversion circuit 1 can be further enhanced.

In the time interval between the time point t0 and the time point t1, the resonant current iLr11 flows through both of the windings T11 and T12. Similarly, in the time interval between the time point t2 and the time point t3, the resonant current iLr12 flows through both of the windings T11 and T12. The resonant frequency of each of the resonant currents iLr11 and iLr12 is equal to the switching frequency.

In other embodiments, the flying capacitor Cb11 has a large capacitance, and the equivalent resonant inductor has a small inductance. Consequently, in the time interval between the time point t0 and the time point t1, the resonant currents iLr11 and iLr12 are respectively greater than the magnetizing currents iLm1 and −iLm1, and the corresponding switches are turned off. In the time interval between the time point t2 and the time point t3, the resonant currents iLr11 and iLr12 are respectively greater than the magnetizing currents iLm1 and −iLm1, and the corresponding switches are turned off. The turn-off current is greater than zero. However, due to the small inductance of the equivalent resonant inductor, the loss caused by the non-zero current in the turn-off situation can actually be ignored. Consequently, the switching period of the power conversion circuit 1 is less than or equal to the resonant period of the resonant current. However, in order to balance the loss and the energy transfer efficiency, it is preferred that the switching period Ts is greater than or equal to 0.5 times the resonant period.

In an embodiment, the voltage gain ratio of the input voltage V1 to the output voltage V2 in the power conversion circuit 1 is (4-2N):1. The voltage gain ratio can be adjusted by changing N. In accordance with the present disclosure, the magnetic element T-1 is additionally equipped with the second winding T13. According to the magnetic coupling relationship, the turn ratio between the second winding T13, the first winding T11 and the first winding T12 is N:1:1. The second winding T13 is set at a specified position of the power conversion circuit 1. By changing the turn number of the second winding T13, the voltage gain ratio of the power conversion circuit 1 can be flexibly designed. Consequently, the application range of the power conversion circuit 1 can be expanded.

As mentioned above, the voltage gain ratio of the input voltage V1 to the output voltage V2 in the power conversion circuit 1 is (4-2N):1. Consequently, the power conversion circuit 1 can be used in application fields that demands a smaller voltage gain. For example, the power conversion circuit 1 can be applied to automotive vehicles.

Please refer to FIG. 1C and FIG. 1D again. The first windings T11 and T12 and the second winding T13 are magnetically coupled to generate corresponding equivalent leakage inductors Lr11, Lr12 and Lr13, respectively. In order to analyze the relationship between the resonant currents more conveniently and concisely, the magnetizing current iLm1 and the magnetizing voltage Vlm1 of the equivalent magnetizing inductor Lm1 are temporarily ignored. In the time interval between the time point t0 and the time point t1 and in the time interval between the time point t2 and the time point t3, the flying capacitor Cb11 resonates with the equivalent leakage inductors Lr11, Lr12, and Lr13. In this embodiment, the equivalent resonant capacitor of the power conversion circuit 1 is the flying capacitor Cb11, and the equivalent resonant inductance is the sum of the equivalent leakage inductances Lr11, Lr12, and Lr13. If the magnetizing current iLm1 is ignored, the output current io of the power conversion circuit 1 can be equivalent to and expressed as the following equation (3):

io=iLr11+iLr12 . . . (3);

In the above equation (3), iLr11 is the resonant current flowing through the equivalent leakage inductor Lr11, and iLr12 is the resonant current flowing through the equivalent leakage inductor Lr12. In the time interval between the time point t0 and the time point t1, the resonant current iLr13 flowing through the equivalent leakage inductor Lr13 is equal to the resonant current iLr11 flowing through the equivalent leakage inductor Lr11. That is, the following equation (4) is obtained.

iLr13=iLr11 . . . (4);

According to the magnetic potential balance, the following equation (5) is obtained:

−N×iLr13+iLr11=iLr12 . . . (5);

From the above equations (3), (4) and (5), it can be deduced that the resonant current iLr12 can be expressed as: iLr12=(1−N)×io/(2−N), and the resonant current iLr11 can be expressed as: iLr11=io/(2−N).

In the time interval between the time point t2 and the time point t3, the resonant current iLr13 flowing through the equivalent leakage inductor Lr13 is equal to the resonant current iLr12 flowing through the equivalent leakage inductor Lr12. That is, the following equation (6) is obtained.

iLr13=iLr12 . . . (6);

According to the magnetic potential balance, the following equation (7) is obtained:

−N×iLr13+iLr12=iLr11 . . . (7)

From the above equations (3), (6) and (7), it can be deduced that the resonant current iLr11 can be expressed as: iLr11=(1−N)×io/(2−N), and the resonant current iLr12 can be expressed as iLr12=io/(2−N).

As mentioned above, since the turn number of the second winding T13 of the magnetic element T-1 is adjustable, the voltage gain ratio of the power conversion circuit 1 can be flexibly designed. Consequently, the application range of the power conversion circuit 1 can be expanded. The sum of the resonant currents iLr11 and iLr12 in the time interval between the time point t0 and the time point t1 and the sum of the resonant currents iLr11 and iLr12 in the time interval between the time point t2 and the time point t3 are equal. In other words, the addition of the second winding T13 does not affect the resonance effect of the power conversion circuit 1.

Furthermore, the terminal voltage Vc11 of the flying capacitor is an AC resonant voltage superimposed on a DC voltage. The typical value of the DC voltage is Vin/2, and thus the typical ratio of the DC voltage to the input voltage is 0.5. When the device parameter distribution or other factors are taken into account, the ratio of the DC voltage to the input voltage (the terminal voltage of the first power terminal of the power conversion circuit 1) is in the range between 0.4 and 0.6. The amplitude of the AC resonant voltage of the terminal voltage Vc11 is determined according to the inductance of the equivalent resonant inductor, the capacitance of the equivalent resonant capacitor, the switching frequency of the power conversion circuit and the load size.

In the above embodiment, the equivalent resonant inductor includes the leakage inductance generated by the coupling between the two first windings T11 and T12 and the second winding T13 of the magnetic element T-1, as well as the parasitic inductance in the circuit. When the resonant period, the switching period and the capacitance of the flying capacitor Cb11 are taken into account, the coupling coefficient between each of the two first windings T11 and T12 and the second winding T13 is preferably greater than 0.9. However, the coupling coefficient is not restricted.

FIG. 1E is a schematic circuit diagram illustrating the circuitry topology of a power conversion circuit according to a second embodiment of the present disclosure. As shown in FIG. 1E, the equivalent resonant inductor includes an external inductor. The external inductor is serially connected between the connection point of the second terminals of the first windings T11 and T12, which have opposite polarities, and the second positive terminal V2+ (i.e., the point A). Alternatively, two external inductors with the same inductance are serially and respectively connected to the first windings T11 and T12 at the point B1, or two external inductors with the same inductance are serially and respectively connected to the first windings T11 and T12 at the point B2. Alternatively, an external inductor is serially connected to the serial branch of the flying capacitor Cb11 and the second winding T13 (at the point C1, C2 or C3). Furthermore, two or three external inductors may be disposed at two or three of the above three locations simultaneously to obtain a suitable resonant period. As shown in FIG. 1E, the external inductor is connected in series between the first terminal of the first switch S11 and the second positive terminal V2+.

In some embodiments, the third switch Sr11 and the fourth switch Sr12 can be replaced by diodes, and the diodes are served as freewheeling diodes. The switching period of the power conversion circuit 1 is less than or equal to the resonant period. The equivalent circuit and the current waveform can be derived from the above embodiment. In the above embodiment, the switches are MOS switches, SiC switches, GaN switches and other controllable switches.

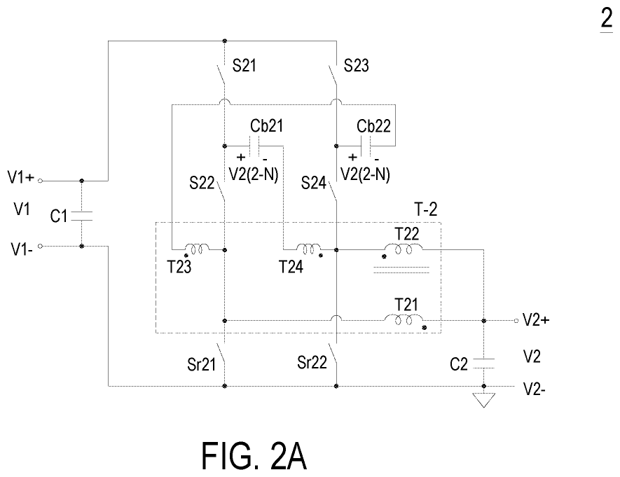

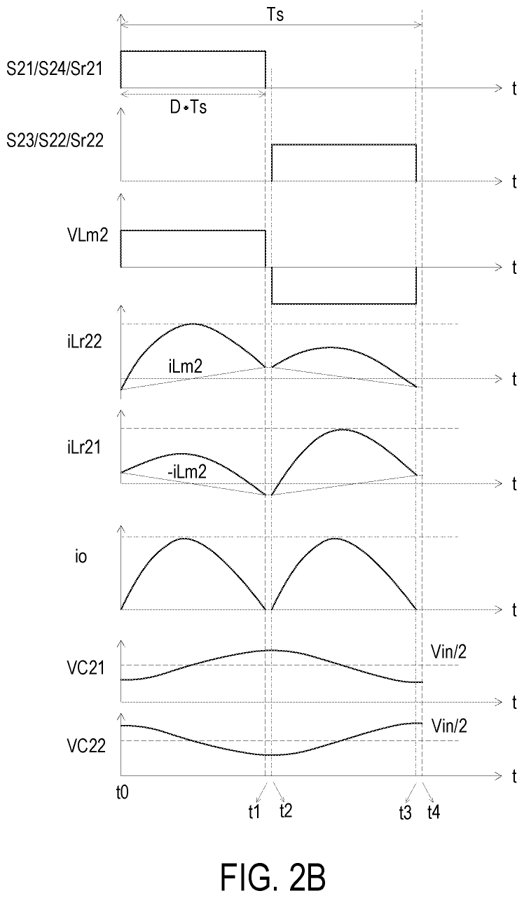

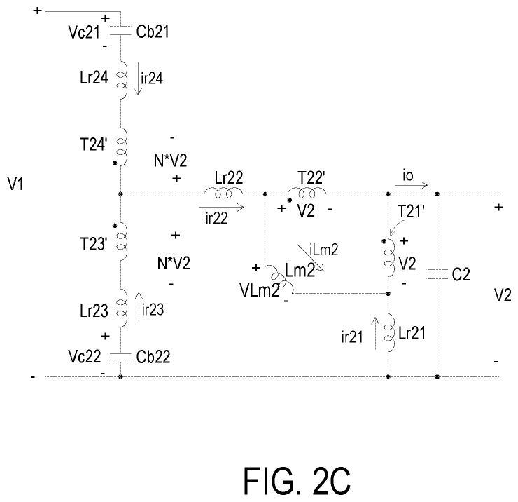

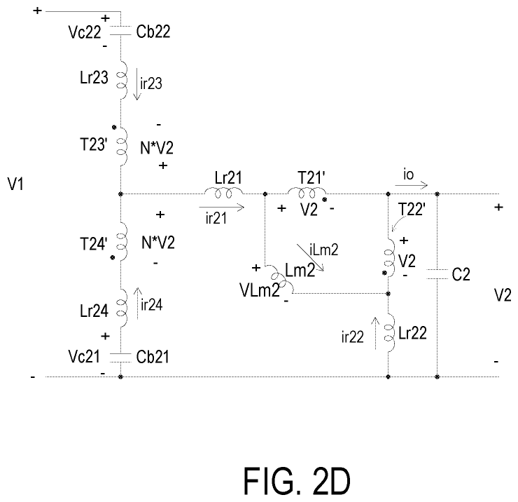

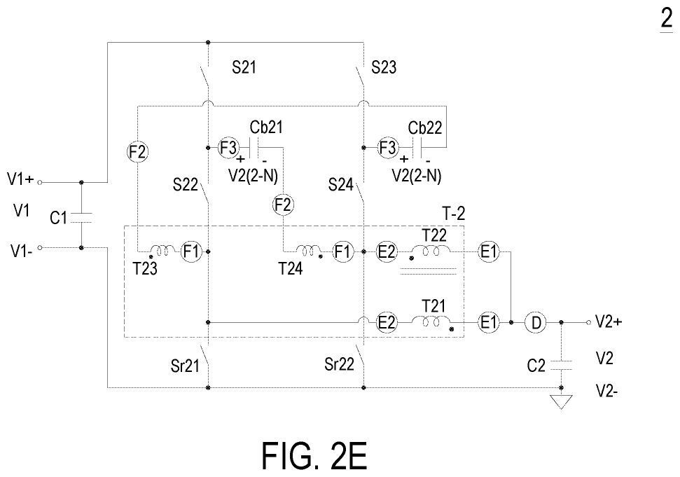

As mentioned above, the power conversion circuit 1 can perform the bidirectional power conversion. In case that the first power terminal of the power conversion circuit 1 is the output terminal, the second power terminal of the power conversion circuit 1 is the input terminal. The operations are similar to the above embodiment, in which the first power terminal of the power conversion circuit 1 is the input terminal and the second power terminal of the power conversion circuit 1 is the output terminal. However, in case that the first power terminal of the power conversion circuit 1 is the output terminal and the second power terminal of the power conversion circuit 1 is the input terminal, the voltage gain ratio of the input voltage to the output voltage in the power conversion circuit 1 is 1: (4−2N).
FIG. 2A is a schematic circuit diagram illustrating the circuitry topology of a power conversion circuit according to a third embodiment of the present disclosure. FIG. 2B is a schematic timing waveform diagram illustrating associated signals of the power conversion circuit shown in FIG. 2A. FIG. 2C is a schematic circuit diagram illustrating the equivalent circuit of the power conversion circuit shown in FIG. 2A in the time interval between the time point t0 and the time point t1 shown in FIG. 2B. FIG. 2D is a schematic circuit diagram illustrating the equivalent circuit of the power conversion circuit shown in FIG. 2A in the time interval between the time point t2 and the time point t3 shown in FIG. 2B.

The power conversion circuit 2 of the embodiment shown in FIG. 2A has a symmetric circuit topology. In this embodiment, the power conversion circuit 2 includes a first power terminal (including a first positive terminal V1+ and a first negative terminal V1−), a second power terminal (including a second positive terminal V2+ and a second negative terminal V2−), a first capacitor C1, a second capacitor C2, a first flying capacitor Cb21, a second flying capacitor Cb22, a first switching power conversion unit, a second switching power conversion unit, and a magnetic element T-2. The first negative terminal V1− and the second negative terminal V2− are connected to a common node (e.g., a ground terminal).

The first switching power conversion unit includes a first switch S21, a second switch S24 and a third switch Sr22. The second switching power conversion unit has a circuitry topology similar to that of the first switching power conversion unit. That is, the second switching power conversion unit includes a fourth switch S23, a fifth switch S22 and a sixth switch Sr21.

The first terminal of the first switch S21 is electrically connected to the first positive terminal V1+. The second terminal of the first switch S21 is electrically connected to the first terminal of the fifth switch S22. The second terminal of the fifth switch S22 is electrically connected to the first terminal of the sixth switch Sr21. The second terminal of the sixth switch Sr21 is electrically connected to the second negative terminal V2−. The first terminal of the fourth switch S23 is electrically connected to the first positive terminal V1+ and is electrically connected to the first switch S21 in parallel. The second terminal of the fourth switch S23 is electrically connected to the first terminal of the second switch S24. The second terminal of the second switch S24 is electrically connected to the first terminal of the third switch Sr22. The second terminal of the third switch Sr22 is electrically connected to the second negative terminal V2−. The first flying capacitor Cb21 is electrically connected between the second terminal of the first switch S21, the second terminal of the second switch S24 and the first terminal of the third switch Sr22. The second flying capacitor Cb22 is electrically connected between the second terminal of the fourth switch S23, the second terminal of the fifth switch S22 and the first terminal of the sixth switch Sr21. In addition, the first switch S21, the second switch S24, the third switch Sr22, the fourth switch S23, the fifth switch S22 and the sixth switch Sr21 perform periodic actions in each switching period. The switching period has a duty cycle.

The on/off states of the first switch S21, the on/off states of the second switch S24 and the on/off states of the sixth switch Sr21 are identical. The on/off states of the fourth switch S23, the on/off states of the fifth switch S22 and the on/off states of the third switch Sr22 are identical. The phase difference between the driving signal of the first switch S21 and the driving signal of the fourth switch S23 is 180 degrees. The on duration of each of the first switch S21 and the fourth switch S23 is less than or equal to a half of the switching period and greater than or equal to 0.4 times the switching period. The first capacitor C1 is electrically connected between the first positive terminal V1+ and the first negative terminal V1−. The second capacitor C2 is electrically connected between the second positive terminal V2+ and the second negative terminal V2−.

The magnetic element T-2 includes two first windings T21 and T22 and two second windings T23 and T24. The two first windings T21 and T22 and the two second windings T23 and T24 are magnetically coupled with each other through a common magnetic core and wound on the same magnetic leg. The second terminals of the first windings T21 and T22, which have opposite polarities, are electrically connected together and connected to the second positive terminal V2+. The first terminal of the first winding T21 is electrically connected to the second terminal of the fifth switch S22 and the first terminal of the sixth switch Sr21. The first terminal of the first winding T22 is electrically connected to the second terminal of the second switch S24 and the first terminal of the third switch Sr22. The second winding T23 and the second flying capacitor Cb22 are electrically connected to each other in series. The serial connection structure of the second winding T23 and the second flying capacitor Cb22 is electrically connected between the second terminal of the fourth switch S23 and the second terminal of the fifth switch S22. The second winding T24 and the first flying capacitor Cb21 are electrically connected to each other in series. The serial connection structure of the second winding T24 and the first flying capacitor Cb21 is electrically connected between the second terminal of the first switch S21 and the second terminal of the second switch S24. The turn ratio of the second winding T23, the second winding T24, the first winding T21 and the second winding T22 is N:N:1:1, where N is a positive integer.

It is noted that the positions of the second winding T23 and the second flying capacitor Cb22 may be exchanged. In an embodiment, the first terminal of the second winding T23 is electrically connected to the first terminal of the first winding T21. The first terminal of the second winding T23 and the first terminal of the first winding T21 have the same polarity. The second terminal of the second winding T23 is electrically connected to the second flying capacitor Cb22. In a variant example, the first terminal of the second flying capacitor Cb22 is electrically connected to the first terminal of the first winding T21, and the second terminal of the second flying capacitor Cb22 is electrically connected to the first terminal of the second winding T23. The first terminal of the second winding T23 and the first terminal of the first winding T21 have the same polarity.

It is noted that the positions of the second winding T24 and the first flying capacitor Cb21 are not limited. In an embodiment, the first terminal of the second winding T24 is electrically connected to the first terminal of the first winding T22 in series. The first terminal of the second winding T24 and the first terminal of the first winding T22 have the same polarity. The second terminal of the second winding T24 is electrically connected to the first flying capacitor Cb21. In a variant example, the first terminal of the first flying capacitor Cb21 is electrically connected to the first terminal of the first winding T22, and the second terminal of the first flying capacitor Cb21 is electrically connected to the first terminal of the second winding T24. The first terminal of the second winding T24 and the first terminal of the first winding T22 have the same polarity.

The voltage gain ratio of the power conversion circuit 2 will be described as follows. For illustration, it is assumed that the first power terminal of the power conversion circuit 2 is the input voltage terminal and the second power terminal of the power conversion circuit 2 is the output voltage terminal. Please refer to FIGS. 2A, 2B, 2C and 2D again. In the steady state of the power conversion circuit 2, the time interval between the time point t0 and the time point t4 is a switching period Ts.

In the time interval between the time point t0 and the time point t1, the first switch S21, the second switch S24 and the sixth switch Sr21 are turned on. This time interval can be designated as a first operating interval. During this interval, the input voltage V1 charges the first flying capacitor Cb21 through the first switch S21, and the energy is transferred to the output terminal through the second winding T24 and the first winding T22. The energy stored in the second flying capacitor Cb22 is transferred to the output terminal through the second switch S24, the first winding T22, the sixth switch Sr21 and the second winding T23. In addition, the first winding T21 provides the freewheeling current through the sixth switch Sr21. Meanwhile, the total current flowing through the second winding T23 and the second winding T24 is equal to the current flowing through the first winding T22. The equivalent circuit is shown in FIG. 2C. In FIG. 2C, T21′, T22′, T23′ and T24′ are the ideal windings corresponding to each winding, Lr21, Lr22, Lr23 and Lr24 are the equivalent leakage inductors corresponding to each winding, and Lm2 is the equivalent magnetizing inductor of the magnetic element T-2.

The equivalent resonant inductor formed by the equivalent leakage inductors Lr21, Lr22, Lr23 and Lr24 resonates with the first flying capacitor Cb21 and the second flying capacitor Cb22 to generate resonant currents iLr21 and iLr22. The magnetizing current in this magnetic element is equivalent to iLm2. During this time interval, the corresponding node voltage relationships in the power conversion circuit 2 can be seen in FIG. 2C. Ideally, the voltage across the first winding T21′ is equal to the voltage at the second power terminal of the power conversion circuit 2 (e.g., V2). The turn ratio of the second winding T23, the second winding T24, the first winding T21 and the second winding T22 is N:N:1:1. Consequently, the ideal voltage across the first winding T22′ is also equal to V2, the ideal voltage across the second winding T23′ is N×V2, and the ideal voltage across the second winding T24′ is N×V2. As a consequence, the voltage V1 at the first power terminal of the power conversion circuit 2 and the voltage Vc22 of the second flying capacitor Cb22 can be expressed as the following equations (8) and (9):

V1=Vc21+(2−N)×V2 . . . (8);

Vc22=(2−n)×V2 . . . (9);

In the above equations (8) and (9), Vc21 is the terminal voltage of the first flying capacitor Cb21, and Vc22 is the voltage of the second flying capacitor Cb22.

At the time point t1, the resonant currents iLr11 and iLr12 are equal to the magnetizing currents iLm1 and −iLm1, respectively. Meanwhile, the first switch S21, the second switch S24 and the sixth switch Sr21 are turned off to achieve the zero current switching (ZCS) function of switches. Consequently, the turn-off loss of switches is reduced, and the energy transfer efficiency of the power conversion circuit 2 is enhanced.

In the time interval between the time point t1 and the time point t2, all switches are turned off. The magnetizing current iLm1 flowing through the magnetic element T-2 provides the freewheeling current to draw charges from the parasitic capacitances across the fourth switch S23, the fifth switch S22 and the third switch Sr22. Consequently, the voltages across the fourth switch S23, the fifth switch S22 and the third switch Sr22 decrease. In an embodiment, when the voltages across the fourth switch S23, the fifth switch S22 and the third switch Sr22 drop to less than 50% of their respective initial voltages (i.e., the voltage across the respective switches at the time point t1), the fourth switch S23, the fifth switch S22 and the third switch Sr22 are turned on. Consequently, the turn-on loss of switches can be reduced, and the energy conversion efficiency and the power density of the power conversion circuit 2 will be enhanced.

In another embodiment, the inductance of the magnetic element T-2 is controlled to allow the inductance of the equivalent magnetizing inductor Lm2 of the magnetic element T-2 to be sufficiently small. That is, the magnetizing current iLm2 flowing through the equivalent magnetizing inductor Lm2 is sufficiently large to completely draw the charges of the parasitic capacitances across the fourth switch S23, the fifth switch S22 and the third switch Sr22. Consequently, the voltages across the fourth switch S23, the fifth switch S22 and the third switch Sr22 drop to zero. After the body diodes of the fourth switch S23, the fifth switch S22 and the third switch Sr22 are turned on, the fourth switch S23, the fifth switch S22 and the third switch Sr22 are turned on to achieve the zero-voltage switching (ZVS) function of switches. Consequently, the turn-on loss of switches can be further reduced, and the energy conversion efficiency and the power density of the power conversion circuit 2 can be further enhanced.

In the time interval between the time point t2 and the time point t3, the fourth switch S23, the fifth switch S22 and the third switch Sr22 are turned on. This time interval can be designated as a second operating interval. During this interval, the input voltage V1 charges the second flying capacitor Cb22 through the fourth switch S23, and the energy is transferred to the output terminal through the second winding T23 and the first winding T21. Meanwhile, the energy stored in the first flying capacitor Cb21 is transferred to the output terminal through the fifth switch S22, the first winding T21, the third switch Sr22 and the second winding T24. In addition, the first winding T22 provides the freewheeling current through the third switch Sr22. Meanwhile, the total current flowing through the second winding T23 and the second winding T24 is equal to the current flowing through the first winding T21. The equivalent circuit is shown in FIG. 2D.

The equivalent resonant inductor formed by the equivalent leakage inductors Lr21, Lr22, Lr23 and Lr24 resonates with the first flying capacitor Cb21 and the second flying capacitor Cb22 to generate resonant currents iLr21 and iLr22. The magnetizing current in this magnetic element is equivalent to iLm2. During this time interval, the corresponding node voltage relationships in the power conversion circuit 2 can be seen in FIG. 2D. Ideally, the voltage across the first winding T22′ is equal to the voltage at the second power terminal of the power conversion circuit 2 (e.g., V2). The turn ratio of the second winding T23, the second winding T24, the first winding T21 and the second winding T22 is N:N:1:1. Consequently, the ideal voltage across the first winding T21′ is also equal to V2, the ideal voltage across the second winding T23′ is N×V2, and the ideal voltage across the second winding T24′ is N×V2. As a consequence, the voltage V1 at the first power terminal of the power conversion circuit 2 and the voltage Vc21 across the first flying capacitor Cb21 can be expressed as the following equations (10) and (11):

V1=Vc22+(2−N)×V2 . . . (10);

Vc21=(2−N)×V2 . . . (11);

The energy stored in the first flying capacitor Cb21 in the time interval between the time point t0 and the time point t1 is transferred to the output terminal in the time interval between the time point t2 and the time point t3. According to the equations (8), (9), (10) and (11), the voltage V1 at the first power terminal of the power conversion circuit 2 can be expressed as: V1=(4−2N)×V2.

At the time point t3, the resonant currents iLr21 and iLr22 are equal to the magnetizing currents iLm2 and −iLm2, respectively. Meanwhile, the fourth switch S23, the fifth switch S22 and the third switch Sr22 are turned off to achieve the zero current switching (ZCS) function of switches. Consequently, the turn-off loss of switches is reduced, and the energy transfer efficiency of the power conversion circuit 2 is enhanced.

In the time interval between the time point t3 and the time point t4, all switches are turned off. The magnetizing current iLm2 flowing through the magnetic element T-2 provides the freewheeling current to draw charges from the parasitic capacitances across the first switch S21, the second switch S24 and the sixth switch Sr21. Consequently, the voltages across the first switch S21, the second switch S24 and the sixth switch Sr21 decrease.

In an embodiment, when the voltages across the first switch S21, the second switch S24 and the sixth switch Sr21 drop to less than 50% of their respective initial voltages (i.e., the voltage across the respective switches at the time point t1), the first switch S21, the second switch S24 and the sixth switch Sr21 are turned on. Consequently, the turn-on loss of switches can be reduced, and the energy conversion efficiency and the power density of the power conversion circuit 2 will be enhanced.

In another embodiment, the inductance of the magnetic element T-2 is controlled to allow the inductance of the equivalent magnetizing inductor Lm2 of the magnetic element T-2 to be sufficiently small. That is, the magnetizing current iLm2 flowing through the equivalent magnetizing inductor Lm2 is sufficiently large to completely draw the charges of the parasitic capacitances across the first switch S21, the second switch S24 and the sixth switch Sr21. Consequently, the voltages across the first switch S21, the second switch S24 and the sixth switch Sr21 drop to zero. After the body diodes of the first switch S21, the second switch S24 and the sixth switch Sr21 are turned on, the first switch S21, the second switch S24 and the sixth switch Sr21 are turned on to achieve the zero-voltage switching (ZVS) function of switches. Consequently, the turn-on loss of switches can be further reduced, and the energy conversion efficiency and the power density of the power conversion circuit 2 can be further enhanced.

In the time interval between the time point t0 and the time point t1, the resonant current iLr21 flows through both of the windings T21 and T22. Similarly, in the time interval between the time point t2 and the time point t3, the resonant current iLr22 flows through both of the windings T21 and T22. The resonant frequency of each of the resonant currents iLr21 and iLr22 is equal to the switching frequency.

In other embodiments, each of the first flying capacitor Cb21 and the second flying capacitor Cb22 has a large capacitance, and each of their equivalent resonant inductors has a small inductance. Consequently, in the time interval between the time point t0 and the time point t1, the resonant currents iLr21 and iLr22 are respectively greater than the magnetizing currents iLm2 and −iLm2, and the corresponding switches are turned off. In the time interval between the time point t2 and the time point t3, the resonant currents iLr21 and iLr22 are respectively greater than the magnetizing currents iLm2 and −iLm2, and the corresponding switches are turned off. The turn-off current is greater than zero. However, due to the small inductance of the equivalent resonant inductor, the loss caused by the non-zero current in the turn-off situation can actually be ignored. Consequently, the switching period of the power conversion circuit 2 is less than or equal to the resonant period of the resonant current. However, in order to balance the loss and the energy transfer efficiency, it is preferred that the switching period Ts is greater than or equal to 0.5 times the resonant period.

In an embodiment, the voltage gain ratio of the input voltage V1 to the output voltage V2 in the power conversion circuit 2 is (4-2N):1, which is not fixed. In accordance with the present disclosure, the magnetic element T-2 is additionally equipped with the second winding T23 and T24. According to the magnetic coupling relationship, turn ratio of the second winding T23, the second winding T24, the first winding T21 and the second winding T22 is N:N:1:1. The second windings T23 and T24 are set at specified positions of the power conversion circuit 2. By changing the turn numbers of the second windings T23 and T24, the voltage gain ratio of the power conversion circuit 2 can be flexibly designed. Consequently, the application range of the power conversion circuit 2 can be expanded.

Please refer to FIG. 2C and FIG. 2D again. The first windings T21 and T22 and the second windings T23 and T24 are magnetically coupled to generate corresponding equivalent leakage inductors Lr21, Lr22, Lr23 and Lr24, respectively. In order to analyze the relationship between the resonant currents more conveniently and concisely, the magnetizing current iLm2 and the magnetizing voltage Vlm2 of the equivalent magnetizing inductor Lm2 are temporarily ignored. In the time interval between the time point t0 and the time point t1 and in the time interval between the time point t2 and the time point t3, the first flying capacitor Cb21 and the second flying capacitor Cb22 resonate with the equivalent leakage inductors Lr21, Lr22, Lr23 and Lr24. In this embodiment, the equivalent resonant capacitance of the power conversion circuit 2 is the sum of the capacitances of the first flying capacitor Cb21 and the second flying capacitor Cb22, and the equivalent resonant inductance of the power conversion circuit 2 is obtained by connecting the equivalent leakage inductances Lr23 and Lr24 in parallel, and then adding them to Lr21 and Lr22 (i.e., the equivalent resonant inductance of the power conversion circuit 2 is Lr23∥Lr24+Lr21+Lr22). If the magnetizing current iLm2 is ignored, the output current io of the power conversion circuit 2 can be equivalent to and expressed as the following equation (12):

io=iLr21+iLr22 . . . (12)

In the above equation (12), iLr21 is the resonant current flowing through the equivalent leakage inductor Lr21, and iLr22 is the resonant current flowing through the equivalent leakage inductor Lr22. In the time interval between the time point t0 and the time point t1, the resonant current iLr23 flowing through the equivalent leakage inductor Lr23 is equal to the resonant current iLr24 flowing through the equivalent leakage inductor Lr24. That is, the following equation (13) is obtained.

iLr23=iLr24 . . . (13);

Furthermore, the sum of the resonant current iLr23 flowing through the equivalent leakage inductor Lr23 and the resonant current iLr24 flowing through the equivalent leakage inductor Lr24 is equal to the resonant current iLr22 flowing through the equivalent leakage inductor Lr22. That is, the following equation (14) is obtained.

iLr23+iLr24=iLr22 . . . (14);

According to the magnetic potential balance, the following equation (15) is obtained:

−M×iLr23−N×iLr24+iLr22=iLr21 . . . (15);

From the above equations (13), (14) and (15), it can be deduced that the resonant current iLr12 can be expressed as: iLr22=io/(2−N, and the resonant current iLr21 can be expressed as: iLr21=(1−N)·io/(2−N).

In the time interval between the time point t2 and the time point t3, the resonant current iL23 flowing through the equivalent leakage inductor Lr23 is equal to the resonant current iLr24 flowing through the equivalent leakage inductor Lr24 (e.g., the equation (13)), and the sum of the resonant current iLr23 flowing through the equivalent leakage inductor Lr23 and the resonant current iLr24 flowing through the equivalent leakage inductor Lr24 is equal to the resonant current iLr22 flowing through the equivalent leakage inductor Lr22 (e.g., the equation (14)).

According to the magnetic potential balance, the following equation (16) is obtained:

−N×iLr23−N×iLr24+iLr21=iLr22 . . . (16);

From the above equations (13), (14) and (16), it can be deduced that the resonant current iLr21 can be expressed as: iLr22=io/(2−N), and the resonant current iLr22 can be expressed as iLr22=(1−N)×io/(2−N).

As mentioned above, since the turn numbers of the second windings T23 and T24 of the magnetic element T-2 are adjustable, the voltage gain ratio of the power conversion circuit 2 can be flexibly designed. The sum of the resonant currents iLr21 and iLr22 in the time interval between the time point t0 and the time point t1 and the sum of the resonant currents iLr21 and iLr22 in the time interval between the time point t2 and the time point t3 are equal. In other words, the addition of the second windings T23 and T24 does not affect the resonance effect of the power conversion circuit 2.

Furthermore, each of the terminal voltage Vc21 of the first flying capacitor Cb21 and the terminal voltage Vc22 of the second flying capacitor Cb22 is an AC resonant voltage superimposed on a DC voltage. The typical value of the DC voltage is Vin/2, and thus the typical ratio of the DC voltage to the input voltage (e.g., the terminal voltage of the power conversion circuit 2) is 0.5. When the device parameter distribution or other factors are taken into account, the ratio of the DC voltage to the input voltage (the terminal voltage of the first power terminal of the power conversion circuit 2) is in the range between 0.4 and 0.6. The amplitude of the AC resonant voltage of each of the terminal voltages Vc21 and Vc22 is determined according to the inductance of the equivalent resonant inductor, the capacitance of the equivalent resonant capacitor, the switching frequency of the power conversion circuit and the load capacity.

FIG. 2E is a schematic circuit diagram illustrating the circuitry topology of a power conversion circuit according to a fourth embodiment of the present disclosure. As shown in FIG. 2E, the equivalent resonant inductor includes an external inductor. The external inductor is serially connected between the connection point of the second terminals of the first windings T21 and T22, which have opposite polarities, and the second positive terminal V2+ (i.e., the point D). Alternatively, two external inductors with the same inductance are serially and respectively connected to the first windings T21 and T22 at the point E1, or two external inductors with the same inductance are serially and respectively connected to the first windings T21 and T22 at the point E2. Alternatively, an external inductor is serially connected to the serial branch of each flying capacitor and the corresponding second winding T13 (at two points F1, F2 or E2). Furthermore, two or three external inductors may be disposed at two or three of the above three locations simultaneously to obtain a suitable resonant period. As shown in FIG. 2E, the external inductor is connected in series between the first terminal of the first switch S21 and the second positive terminal V2+.

In some embodiments, the third switch Sr22 and the sixth switch Sr21 can be replaced by diodes, and the diodes are served as freewheeling diodes. The switching period of the power conversion circuit is less than or equal to the resonant period. The equivalent circuit and the current waveform can be derived from the above embodiment. In the above embodiment, the switches are MOS switches, SiC switches, GaN switches and other controllable switches.

As mentioned above, the power conversion circuit 2 can perform the bidirectional power conversion. In case that the first power terminal of the power conversion circuit 2 is the output terminal, the second power terminal of the power conversion circuit 2 is the input terminal. The operations are similar to the above embodiment, in which the first power terminal of the power conversion circuit is the input terminal and the second power terminal of the power conversion circuit is the output terminal. However, in case that the first power terminal of the power conversion circuit 2 is the output terminal and the second power terminal of the power conversion circuit 2 is the input terminal, the voltage gain ratio of the input voltage to the output voltage in the power conversion circuit 2 is 1:(4−2N).

In order to meet the requirements of high current applications, the present disclosure further provides a power converter. The power converter includes M power conversion circuits, wherein M is greater than 1. The M power conversion circuits are connected to each other in an interleaved manner to increase the load capacity of the power converter. The first power terminals of the M power conversion circuits are electrically connected to each other in parallel. The second power terminals of the M power conversion circuits are electrically connected to each other in parallel. The M power conversion circuits have the same circuitry topology and substantially the same circuit parameters.

For example, the power converter includes M power conversion circuits with the circuitry topology shown in FIG. 1A. In case that M is an odd number, the M power conversion circuits are respectively controlled by M control signals. In addition, each control signal is used to control one of the power conversion circuits. The phase angle between every two adjacent control signals is an angle of any value between [360/M−20, 360/M+20] degrees. In case that M is an even number, the M power conversion circuits are controlled by M/2 control signals. In addition, each control signal is used to control two of the power conversion circuits. For example, the m-th control signal is used to control the m-th and the (M/2+m)-th power conversion circuits. The phase angle between every two adjacent control signals is an angle of any value between [360/M−20, 360/M+20] degrees, where m is an integer greater than 1 and less than M.

Alternatively, the power converter includes M power conversion circuits with the circuitry topology shown in FIG. 2A. The M power conversion circuits are respectively controlled by M control signals. In addition, each control signal is used to control one of the power conversion circuits. The phase angle between every two adjacent control signals is an angle of any value between [360/2M−20, 360/2M+20] degrees.

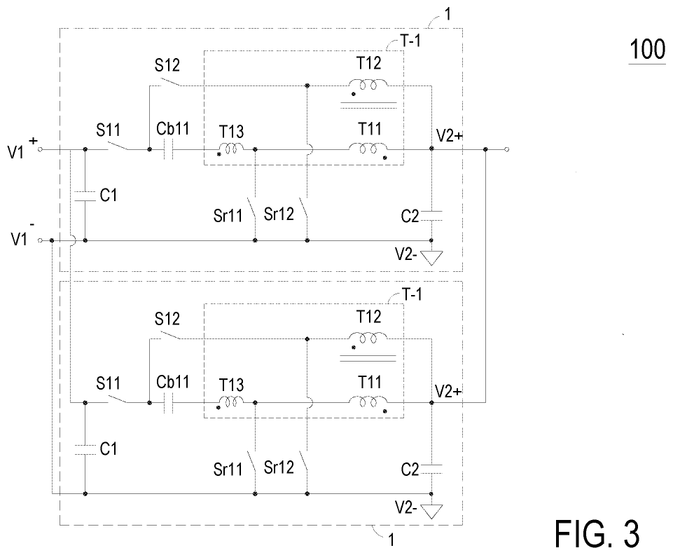

In the following embodiment, two power conversion circuits are connected to each other in an interleaved manner. FIG. 3 is a schematic circuit diagram illustrating the circuitry topology of a power converter according to a first embodiment of the present disclosure. In this embodiment, the power converter 100 includes two power conversion circuits 1 shown in FIG. 1A. The first terminals of the two power conversion circuits 1 are electrically connected in parallel. The second terminals of the two power conversion circuits 1 are also electrically connected in parallel. In this embodiment, each of the two power conversion circuits 1 in the power converter 100 includes a first capacitor C1 and a second capacitor C2. In a variant example, the first terminals of the two power conversion circuits 1 share a single first capacitor C1, and the second terminals of the two power conversion circuits 1 share a single second capacitor C2.

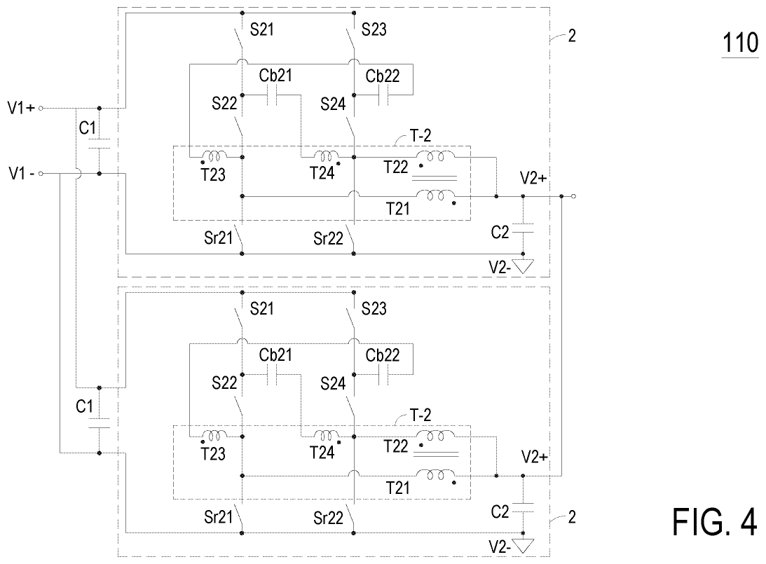

FIG. 4 is a schematic circuit diagram illustrating the circuitry topology of a power converter according to a second embodiment of the present disclosure. In this embodiment, the power converter 110 includes two power conversion circuits 2 shown in FIG. 2A. The first power terminals of the two power conversion circuits 2 are electrically connected in parallel. The second power terminals of the two power conversion circuits 2 are also electrically connected in parallel. In this embodiment, each of the two power conversion circuits 2 in the power converter 110 includes a first capacitor C1 and a second capacitor C2. In a variant example, the first terminals of the two power conversion circuits 2 share a single first capacitor C1, and the second terminals of the two power conversion circuits 2 share a single second capacitor C2.

From the above descriptions, the present disclosure provides a power conversion circuit and a power converter. The magnetic element of the power conversion circuit includes two first windings and a second winding. The two first windings and the second winding are magnetically coupled with each other. The turn ratio between the second winding and the first winding is N:1. By changing the turn number of the second winding, the voltage gain ratio of the power conversion circuit can be flexibly designed. Consequently, the application range of the power conversion circuit can be expanded.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power conversion circuit, comprising:
a first power terminal comprising a first positive terminal and a first negative terminal;
a second power terminal comprising a second positive terminal and a second negative terminal, wherein the second negative terminal is electrically connected to the first negative terminal;
a first switching power conversion unit comprising a first switch and a third switch, which are electrically connected to each other in series;
a second switching power conversion unit comprising a second switch and a fourth switch, which are electrically connected to each other in series, wherein a first terminal of the first switch is electrically connected to a first terminal of the second switch, a second terminal of the first switch is electrically connected to the first positive terminal, the third switch is electrically connected to the first switch in series, the fourth switch is electrically connected to the second switch in series, a first terminal of the third switch and a first terminal of the fourth switch are electrically connected to the first negative terminal, and a second terminal of the fourth switch is electrically connected to a second terminal of the second switch, wherein the first switch, the second switch, the third switch and the fourth switch perform periodic actions in a switching period, and the switching period has a duty cycle;
a flying capacitor; and
a magnetic element comprising two first windings and a second winding, which are magnetically coupled with each other, wherein second terminals of the two first windings have opposite polarities and are electrically connected together and connected to the second positive terminal, a first terminal of a first one of the two first windings is electrically connected to the second terminal of the third switch, a first terminal of a second one of the two first windings is electrically connected between the second terminal of the fourth switch and a second terminal of the second switch, and the second winding and the flying capacitor are electrically connected in series between the first terminal of the first switch and the first terminal of the first one of the two first windings, wherein a first terminal of the second winding and the first terminal of the first one of the two first windings have a same polarity, and a turn ratio between the second winding, the first one of the two first windings and the second one of the two first windings is N:1:1, where N is a positive number,
wherein the switching period comprises a first operating interval and a second operating interval, wherein during the first operating interval, a current flowing through the second winding is equal to a current flowing through the first one of the two first windings, wherein during the second operating interval, the current flowing through the second winding is equal to a current flowing through the second one of the two first windings.

2. The power conversion circuit according to claim 1, wherein the power conversion circuit is a bidirectional power conversion circuit, wherein the first power terminal of the power conversion circuit is an input terminal and the second power terminal of the power conversion circuit is an output terminal, or the first power terminal of the power conversion circuit is the output terminal and the second power terminal of the power conversion circuit is the input terminal.

3. The power conversion circuit according to claim 1, wherein the first terminal of the second winding is electrically connected to the first terminal of the first one of the two first windings, and the second terminal of the second winding is electrically connected to a first terminal of the flying capacitor, or the first terminal of the flying capacitor is electrically connected to the first terminal of the first one of the two first windings, and a second terminal of the flying capacitor is electrically connected to the first terminal of the second winding.

4. The power conversion circuit according to claim 1, wherein a switching state of the first switch and a switching state of the fourth switch are identical, a switching state of the second switch and a switching state of the third switch are identical, a phase difference between a driving signal for driving the first switch and a driving signal for driving the second switch is 180 degrees, and an on duration of each of the first switch and the second switch is less than or equal to a half of the switching period and greater than or equal to 0.4 times the switching period.

5. The power conversion circuit according to claim 1, wherein the power conversion circuit comprises an equivalent resonant inductor, which resonates with the flying capacitor at a resonant frequency and a resonant period, wherein the switching period of the power conversion circuit is less than or equal to the resonant period, and the switching period is greater than or equal to a half of the resonant period.

6. The power conversion circuit according to claim 5, wherein the equivalent resonant inductor comprises a leakage inductor of the magnetic element and a parasitic inductance in circuits, or the equivalent resonant inductor comprises an external inductor that is serially connected between the first terminal of the first switch and the second positive terminal.

7. The power conversion circuit according to claim 1, wherein the two first windings and the second winding are wound around a magnetic leg of a magnetic core of the magnetic element, and a coupling coefficient between every two of the two first windings and the second winding is greater than 0.9.

8. The power conversion circuit according to claim 1, wherein during the switching period, the flying capacitor stores energy or transfers the energy to an output terminal of the power conversion circuit in response to on/off states of the corresponding switches, wherein a ratio of a DC voltage of the flying capacitor to a terminal voltage of the first power terminal of the power conversion circuit is in a range between 0.4 and 0.6.

9. The power conversion circuit according to claim 1, wherein a voltage gain ratio of a terminal voltage of the first power terminal of the power conversion circuit to a terminal voltage of the second power terminal of the power conversion circuit is (4−2N):1.

10. A power conversion circuit, comprising:
a first power terminal comprising a first positive terminal and a first negative terminal;
a second power terminal comprising a second positive terminal and a second negative terminal, wherein the second negative terminal is electrically connected to the first negative terminal;
a first flying capacitor;
a second flying capacitor;
a first switching power conversion unit comprising a first switch, a second switch and a third switch, wherein a first terminal of the first switch is electrically connected to the first positive terminal, a second terminal of the second switch is electrically connected to a first terminal of the third switch, and a second terminal of the third switch is electrically connected to the second negative terminal;
a second switching power conversion unit comprising a fourth switch, a fifth switch and a sixth switch, wherein a first terminal of the fourth switch is electrically connected to the first positive terminal, a second terminal of the fifth switch is electrically connected to a first terminal of the sixth switch, a second terminal of the sixth switch is electrically connected to the second negative terminal, a second terminal of the fourth switch is electrically connected to a first terminal of the second switch, and a first terminal of the fifth switch is electrically connected to the second terminal of the first switch, wherein the first switch, the second switch, the third switch, the fourth switch, the fifth switch and the sixth switch perform periodic actions in a switching period, and the switching period has a duty cycle; and
a magnetic element comprising two first windings and two second windings, which are magnetically coupled with each other, wherein second terminals of the two first windings have opposite polarities and are electrically connected together and connected to the second positive terminal, a first terminal of a first one of the two first windings is electrically connected to the second terminal of the fifth switch and the first terminal of the sixth switch, a first terminal of a second one of the two first windings is electrically connected between the second terminal of the second switch and the first terminal of the third switch, a first one of the two second windings and the second flying capacitor are electrically connected in series between the second terminal of the fourth switch and the second terminal of the fifth switch, and a second one of the two second windings and the first flying capacitor are electrically connected in series between the second terminal of the first switch and the second terminal of the second switch, a first terminal of the first one of the two second windings and the first terminal of the first one of the two first windings have a same polarity and are electrically connected to each other, and a turn ratio between the first one of the two second windings, the second one of the two second windings, the first one of the two first windings and the second one of the two first windings is N:N:1:1, where N is a positive number,
wherein the switching period comprises a first operating interval and a second operating interval, wherein during the first operating interval, a total current flowing through the two second windings is equal to a current flowing through the first one of the two first windings, wherein during the second operating interval, the total current flowing through the two second windings is equal to a current flowing through the second one of the two first windings.

11. The power conversion circuit according to claim 10, wherein the power conversion circuit is a bidirectional power conversion circuit, wherein the first power terminal of the power conversion circuit is an input terminal and the second power terminal of the power conversion circuit is an output terminal, or the first power terminal of the power conversion circuit is the output terminal and the second power terminal of the power conversion circuit is the input terminal.

12. The power conversion circuit according to claim 10, wherein a second terminal of the first one of the two second windings is electrically connected to the second flying capacitor, and a second terminal of the second one of the two second windings is electrically connected to the first flying capacitor.

13. The power conversion circuit according to claim 10, wherein a first terminal of the second flying capacitor is electrically connected to the first terminal of the first one of the two first windings, a second terminal of the second flying capacitor is electrically connected to a first terminal of the first one of the two second windings, a first terminal of the first flying capacitor is electrically connected to the first terminal of the second one of the two first windings, and a second terminal of the first flying capacitor is electrically connected to a first terminal of the second one of the two second windings.

14. The power conversion circuit according to claim 10, wherein a switching state of the first switch, a switching state of the second switch and a switching state of the sixth switch are identical, a switching state of the third switch, a switching state of the fourth switch and a switching state of the fifth switch are identical, a phase difference between a driving signal for driving the first switch and a driving signal for driving the fourth switch is 180 degrees, and an on duration of each of the first switch and the fourth switch is less than or equal to a half of the switching period and greater than or equal to 0.4 times the switching period.

15. The power conversion circuit according to claim 10, wherein the power conversion circuit comprises an equivalent resonant inductor, which resonates with the first flying capacitor and the second flying capacitor at a resonant frequency and a resonant period, wherein the switching period of the power conversion circuit is less than or equal to the resonant period, and the switching period is greater than or equal to a half of the resonant period.

16. The power conversion circuit according to claim 15, wherein the equivalent resonant inductor comprises a leakage inductor of the magnetic element and a parasitic inductance in circuits, or the equivalent resonant inductor comprises an external inductor that is serially connected between the first terminal of the first switch and the second positive terminal.

17. The power conversion circuit according to claim 10, wherein the two first windings and the two second windings are wound around a magnetic leg of a magnetic core of the magnetic element, and a coupling coefficient between every two of the two first windings and the two second windings is greater than 0.9.

18. The power conversion circuit according to claim 10, wherein during the switching period, the first flying capacitor and the second flying capacitor store energy or transfer the energy to an output terminal of the power conversion circuit in response to on/off states of the corresponding switches, wherein a ratio of a DC voltage of each of the first flying capacitor and the second flying capacitor to a terminal voltage of the first power terminal of the power conversion circuit is in a range between 0.4 and 0.6.

19. The power conversion circuit according to claim 10, wherein a voltage gain ratio of a terminal voltage of the first power terminal of the power conversion circuit to a terminal voltage of the second power terminal of the power conversion circuit is (4−2N):1.

20. A power converter, comprising:
M power conversion circuits, wherein M is an integer greater than 1, and each of the M power conversion circuits comprises:
a first power terminal comprising a first positive terminal and a first negative terminal;
a second power terminal comprising a second positive terminal and a second negative terminal, wherein the second negative terminal is electrically connected to the first negative terminal;
a first switching power conversion unit comprising a first switch and a third switch, which are electrically connected to each other in series;
a second switching power conversion unit comprising a second switch and a fourth switch, which are electrically connected to each other in series, wherein a first terminal of the first switch is electrically connected to a first terminal of the second switch, a second terminal of the first switch is electrically connected to the first positive terminal, the third switch is electrically connected to the first switch in series, the fourth switch is electrically connected to the second switch in series, a first terminal of the third switch and a first terminal of the fourth switch are electrically connected to the first negative terminal, and a second terminal of the fourth switch is electrically connected to a second terminal of the second switch, wherein the first switch, the second switch, the third switch and the fourth switch perform periodic actions in a switching period, and the switching period has a duty cycle;
a flying capacitor; and
a magnetic element comprising two first windings and a second winding, which are magnetically coupled with each other, wherein second terminals of the two first windings have opposite polarities and are electrically connected together and connected to the second positive terminal, a first terminal of a first one of the two first windings is electrically connected to the second terminal of the third switch, a first terminal of a second one of the two first windings is electrically connected between the second terminal of the fourth switch and a second terminal of the second switch, and the second winding and the flying capacitor are electrically connected in series between the first terminal of the first switch and the first terminal of the first one of the two first windings, wherein a first terminal of the second winding and the first terminal of the first one of the two first windings have a same polarity, and a turn ratio between the second winding, the first one of the two first windings and the second one of the two first windings is N:1:1, where N is a positive number,
wherein the switching period comprises a first operating interval and a second operating interval, wherein during the first operating interval, a current flowing through the second winding is equal to a current flowing through the first one of the two first windings, wherein during the second operating interval, the current flowing through the second winding is equal to a current flowing through the second one of the two first windings,
wherein the first power terminals of the M power conversion circuits are electrically connected to each other in parallel, and the second power terminals of the M power conversion circuits are electrically connected to each other in parallel,
wherein if M is an odd number, the M power conversion circuits are respectively controlled by M control signals, and a phase angle between every two adjacent control signals is an angle of any value between [360/M−20, 360/M+20] degrees,
wherein if M is an even number, the M power conversion circuits are controlled by M/2 control signals, an m-th and an (M/2+m)-th power conversion circuits are controlled by an m-th control signal, and a phase angle between every two adjacent control signals is an angle of any value between [360/M−20, 360/M+20] degrees.

21. A power converter, comprising:
M power conversion circuits, wherein M is an integer greater than 1, and each of the M power conversion circuits comprises:
a first power terminal comprising a first positive terminal and a first negative terminal;
a second power terminal comprising a second positive terminal and a second negative terminal, wherein the second negative terminal is electrically connected to the first negative terminal;
a first flying capacitor;
a second flying capacitor;
a first switching power conversion unit comprising a first switch, a second switch and a third switch, wherein a first terminal of the first switch is electrically connected to the first positive terminal, a second terminal of the second switch is electrically connected to a first terminal of the third switch, and a second terminal of the third switch is electrically connected to the second negative terminal;
a second switching power conversion unit comprising a fourth switch, a fifth switch and a sixth switch, wherein a first terminal of the fourth switch is electrically connected to the first positive terminal, a second terminal of the fifth switch is electrically connected to a first terminal of the sixth switch, a second terminal of the sixth switch is electrically connected to the second negative terminal, a second terminal of the fourth switch is electrically connected to a first terminal of the second switch, and a first terminal of the fifth switch is electrically connected to the second terminal of the first switch, wherein the first switch, the second switch, the third switch, the fourth switch, the fifth switch and the sixth switch perform periodic actions in a switching period, and the switching period has a duty cycle; and
a magnetic element comprising two first windings and two second windings, which are magnetically coupled with each other, wherein second terminals of the two first windings have opposite polarities and are electrically connected together and connected to the second positive terminal, a first terminal of a first one of the two first windings is electrically connected to the second terminal of the fifth switch and the first terminal of the sixth switch, a first terminal of a second one of the two first windings is electrically connected between the second terminal of the second switch and the first terminal of the third switch, a first one of the two second windings and the second flying capacitor are electrically connected in series between the second terminal of the fourth switch and the second terminal of the fifth switch, and a second one of the two second windings and the first flying capacitor are electrically connected in series between the second terminal of the first switch and the second terminal of the second switch, a first terminal of the first one of the two second windings and the first terminal of the first one of the two first windings have a same polarity and are electrically connected to each other, and a turn ratio between the first one of the two second windings, the second one of the two second windings, the first one of the two first windings and the second one of the two first windings is N:N:1:1, where N is a positive number,
wherein the switching period comprises a first operating interval and a second operating interval, wherein during the first operating interval, a total current flowing through the two second windings is equal to a current flowing through the first one of the two first windings, wherein during the second operating interval, the total current flowing through the two second windings is equal to a current flowing through the second one of the two first windings,
wherein the first power terminals of the M power conversion circuits are electrically connected to each other in parallel, and the second power terminals of the M power conversion circuits are electrically connected to each other in parallel,
wherein the M power conversion circuits are respectively controlled by M control signals, and a phase angle between every two adjacent control signals is an angle of any value between [360/2M−20, 360/2M+20] degrees.
